(19) United States
(12) Patent Application Publication
(10) Pub. No.: US 2014/0215799 A1
(43) Pub. Date: Aug. 7, 2014

(54) CIPP Chilled Lubrication System

(71) Applicant: Jeffrey M. Tanner, Zanesville, OH (US)

(72) Inventor: Jeffrey M. Tanner, Zanesville, OH (US)

(21) Appl. No.: 14/132,601

(22) Filed: Dec. 18, 2013

Related U.S. Application Data
(63) Continuation-in-part of application No. 13/761,375, filed on Feb. 7, 2013.

(51) Int. Cl. F16L 55/165

(52) U.S. Cl. CPC F16L 55/165
USPC 29/458; 427/209; 427/211

(57) ABSTRACT

A CIPP chilled lubrication system for effectively and safely lubricating a CIPP liner for installation within a conduit. The CIPP chilled lubrication system generally includes a lubricant applicator having a reservoir filled with a gel lubricant and a plurality of rollers that guide the CIPP liner through the gel lubricant prior to entry into an air inverter unit. The gel lubricant is chilled to a temperature of 35 degrees Fahrenheit or lower prior to being applied to the CIPP liner.

### CROSS REFERENCE TO RELATED APPLICATIONS

I hereby claim benefit under Title 35, United States Code, Section 120 of United

States patent application Ser. No. 13/761,375 filed Feb. 7, 2013. This application is a continuation-in-part of the Ser. No. 13/761,375 application. The Ser. No. 13/761,375 application is currently pending. The Ser. No. 13/761,375 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to cured-in-place pipe (CIPP) liner lubrication and more specifically it relates to a CIPP chilled lubrication system for effectively and safely lubricating a CIPP liner for installation within a conduit.

2. Description of the Related Art

Any discussion of the related art throughout the specification should in no way be considered as an admission that such related art is widely known or forms part of common general knowledge in the field.

CIPP liners have been used for many years for the rehabilitation of different types and sizes of conduit and piping systems such as utility, sewer, water, electric, telecom, industrial, petroleum, fire suppression, heating, cooling and the like. The majority of materials used to manufacture these liners is felt and fleece type fabrics which have a thin flexible PVC or Polyurethane type jacket coating on one side. The liners are usually impregnated with a thermosetting type resin then installed by inverting the liner inside of the host conduit or pipe with air or water. The liners may be stored with a refrigerated truck to keep the temperature of the resin within the liners at a cooler temperature which is helpful in extending the curing time of the resin within the liner. There are many types of CIPP lining inversion systems including canister or drum styles and non-canister styles or “shooters”. Another method of inserting the liners is by pulling the liners through the host pipe.

One problem facing the lining contractor is friction caused by the inversion of the CIPP liner. When the liner is being inverted into an existing pipe or conduit, it creates drag or friction against itself. This friction slows down the inversion installation and sometimes prevents the liner from being fully inverted into the pipe or conduit. Also, the longer the CIPP liner the more friction is created, especially when the liner must negotiate around tight pipe or conduit fittings.

The current solution to reduce this friction or drag is the use of liquid lubricants such as oils (e.g. vegetable oil) or detergents (e.g. liquid detergent such as dish washing liquid). The application method is usually performed by spraying the liquid lubricant onto the liner prior to being loaded into the inversion canister or shooter. This application does not apply the lubricants to the liner in a consistent manner. Also, due to the fact they are in a liquid form, they can only be applied in a thin coating and any excess runs off the liner wastefully.

Liquid lubricants are not suitable for chilling because the liquid lubricant's viscosity increases becoming tacky and sticky thereby losing its lubricating qualities when chilled. Also, the use of liquid lubricants causes safety and overspray issues since when the liquid lubricant is sprayed onto the liner, overspray can accrue to the surrounding areas. This overspray can create a slip hazard and could cause damage to the surrounding areas. The other problem with liquid lubricants is the back spray that can occur when the liquid lubricated liner is being inverted with a shooter style inversion system (non-sealed canister style). As the liner passes through the opening of the shooter, air pressure is applied to the liner which causes it to be inverted into the pipe or conduit. This air pressure can escape from the loading portion of the shooter inversion unit, taking with it the liquid lubricant on the liner. This back spray is pressured out of the shooter unit into the air possibly spraying people, cars, buildings or anything else that may be in the sprays path.

Because of the inherent problems with the related art, there is a need for a new and improved CIPP chilled lubrication system for effectively and safely lubricating a CIPP liner for installation within a conduit.

### BRIEF SUMMARY OF THE INVENTION

The invention generally relates to a CIPP liner lubricant system which includes a lubricant applicator having a reservoir filled with a gel lubricant and a plurality of rollers that guide the CIPP liner through the gel lubricant prior to entry into an air inverter unit. There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention with a canister type of air inverter unit.

FIG. 2 is an upper perspective view of the present invention with a shooter type of air inverter unit.

FIG. 3 is an upper perspective view of the lubricant applicator.

FIG. 4 is a side cutaway view of the present invention in operation applying a gel lubricant to the CIPP liner.

FIG. 5 is a magnified side cutaway view of the present invention applying a gel lubricant to the CIPP liner.

FIG. 6 is an upper perspective view of storage containers containing a volume of gel lubricant positioned within an exemplary cooling apparatus to lower the temperature of the gel lubricant to a target temperature.

FIG. 7 is an upper perspective view of the storage containers positioned within an insulated transportation cooler for transportation to an installation site.

FIG. 8 is a flowchart illustrating the overall cooling, transportation and installation process for the cooled gel lubricant.

### DETAILED DESCRIPTION OF THE INVENTION

### A. Overview

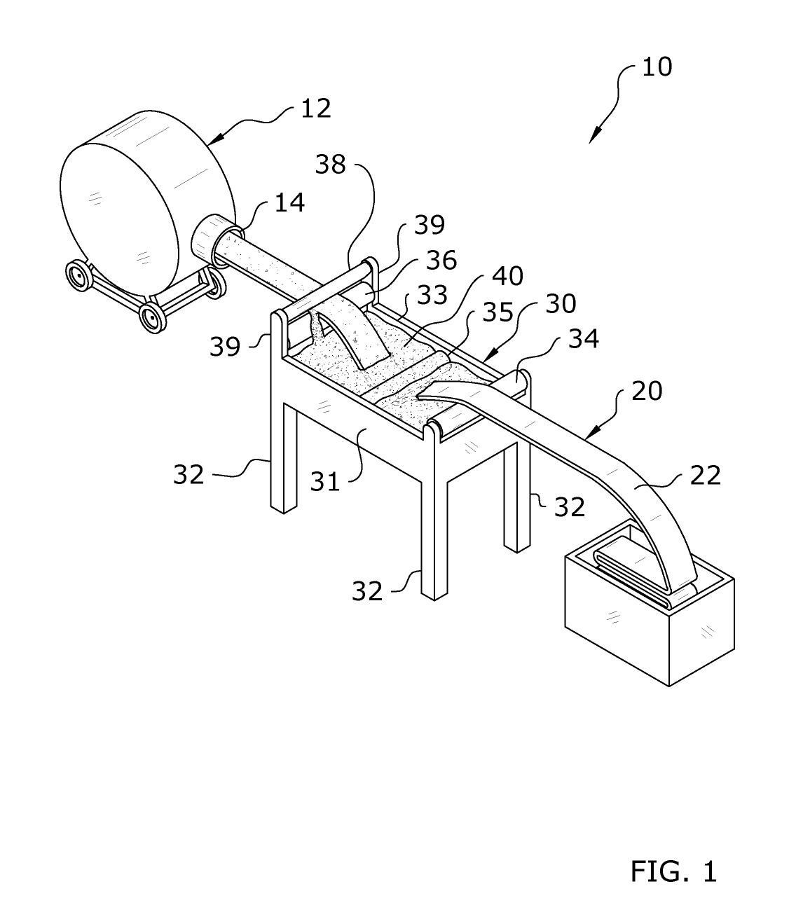

Turning now descriptively to the drawings, in which similar reference characters denote similar elements throughout the several views, FIGS. 1 through 8 illustrate a CIPP chilled lubrication system 10, which comprises a lubricant applicator 30 having a reservoir 31 filled with a gel lubricant 40 and a plurality of rollers that guide the CIPP liner 20 through the gel lubricant 40 prior to entry into an air inverter unit 12.

### B. CIPP Liner

FIGS. 1, 2, 4 and 5 illustrate an exemplary cured-in-place pipe (CIPP) liner having an exterior surface. The CIPP liner 20 has an outer diameter that corresponds to the interior diameter of the conduit 18 to be installed in. The CIPP liner 20 can be utilized to rehabilitate conduit 18 having diameters ranging from 0.1 to 2.8+ meters.

The CIPP liner 20 may be comprised of various materials such as but not limited to non-woven polyester felt, fibre reinforced fabric, polyester felt, glass reinforced polyester felt, glass fibre structured fabric, circular woven polyester fibre hose, woven hose plus felt, and woven hose plus felt and structured glass fibre fabric. The CIPP liner 20 is typically impregnated with a polyester resin or epoxy resin.

The CIPP liner 20 may be installed within a conduit 18 (e.g. pipe, gas pipelines, water pipelines, sewer pipelines) by either pulling the CIPP liner 20 through the conduit 18 or inserted through a liner inversion process with an air inverter unit 12. Regardless of the installation process used, the CIPP liner 20 is initially in a compact flattened state and folded within a storage container as shown in FIGS. 1, 2, 4 of the drawings. The exterior surface of the CIPP liner 20 is comprised of a first surface 22 and a second surface 24 in opposition to the first surface 22. The first surface 22 of the CIPP liner 20 is substantially parallel with respect to the second surface 24 and two opposing edge portions are positioned between the surfaces 22, 24. If the CIPP liner 20 is inverted prior to installation for usage with an air inverter unit 12, it is preferable to lubricate the exterior surface of the CIPP liner 20 prior to the CIPP liner 20 entering the air inverter unit 12 to reduce the friction caused by the inversion of the CIPP liner 20. During the inversion process, the exterior surface eventually becomes the interior surface of the CIPP liner 20 once installed within the conduit 18. After the CIPP liner 20 is positioned within the conduit 18, thermal curing with steam or heated water forced through the CIPP liner 20 pushes the liner against the interior walls of the conduits 18 and cures the impregnated resin within the CIPP liner 20. UV light may also be utilized to cure the CIPP liner 20 within the conduit 18.

### C. Gel Lubricant

The present invention utilizes a gel lubricant 40 instead of a liquid lubricant to provide for adequate, efficient and consistent lubrication of the exterior surface of the CIPP liner 20. The gel lubricant 40 clings well to the exterior surface of the CIPP liner 20 and remains on the exterior surface of the CIPP liner 20 during the inversion process thereby significantly reducing friction. The gel lubricant 40 also significantly reduces back spray commonly encountered with liquid lubricants since the gel lubricant 40 is not susceptible to being blown off. The gel lubricant 40 does not harm the CIPP liner 20 and after a short period of time the gel lubricant 40 evaporates leaving no residue providing a professional finish.

The gel lubricant 40 is not a liquid lubricant or a wax lubricant. The gel lubricant 40 has a viscosity between a liquid lubricant and a wax lubricant. In particular, the gel lubricant 40 has a viscosity greater than 5,000 cPs at 25 degrees Celsius. It is preferable that the gel lubricant 40 has a viscosity greater than 9,500 cPs at 25 degrees Celsius and less than 250,000 cPs at 25 degrees Celsius. It is further preferable that the gel lubricant 40 have a viscosity of 10,000 cPs to 20,000 cPs. The gel lubricant 40 preferably is comprised of a polymer base having a PH range of 6.0 to 8.0. The gel lubricant 40 is preferably comprised of a water and polymer solution forming a viscous gel. A preferred gel lubricant 40 suitable for use within the present invention is sold under the name GREENLEE CLEAR GEL manufactured by Greenlee Textron Inc., a subsidiary of Textron, Inc. which is a cable pulling lubricant for electrical and data communication cable pulls.

### D. Gel Applicator

The gel lubricant 40 may be applied to the exterior surface of the CIPP liner 20 either manually or by utilizing a lubricant applicator 30 that the CIPP liner 20 passes through. For manual application of the gel lubricant 40, the gel lubricant 40 may be applied utilizing a brush, roller (e.g. painter's roller), a cloth, hands of the applicator and the like. Alternatively, an automatic applicator system is preferably utilized to apply the gel lubricant 40 to the CIPP liner 20. The automatic applicator system preferably is positioned between the folded CIPP liner 20 and the insertion device (e.g. air inverter unit 12) to apply the gel lubricant 40 to the exterior surface of the CIPP liner 20 prior to installation within the conduit 18 as illustrated in FIGS. 1, 2 and 4 of the drawings. FIGS. 1 through 5 illustrate a preferred lubricant applicator 30 that is comprised of a reservoir 31 having an interior portion 37 that stores a volume of the gel lubricant 40. One or more support legs 32 support the reservoir 31 to a desired height. The CIPP liner 20 passes through the interior portion 37 of the lubricant applicator 30 and is immersed within the gel lubricant 40 whereby a portion of the gel lubricant 40 attaches to the exterior surface of the CIPP liner 20 as illustrated in FIGS. 1, 2, 4 and 5 of the drawings.

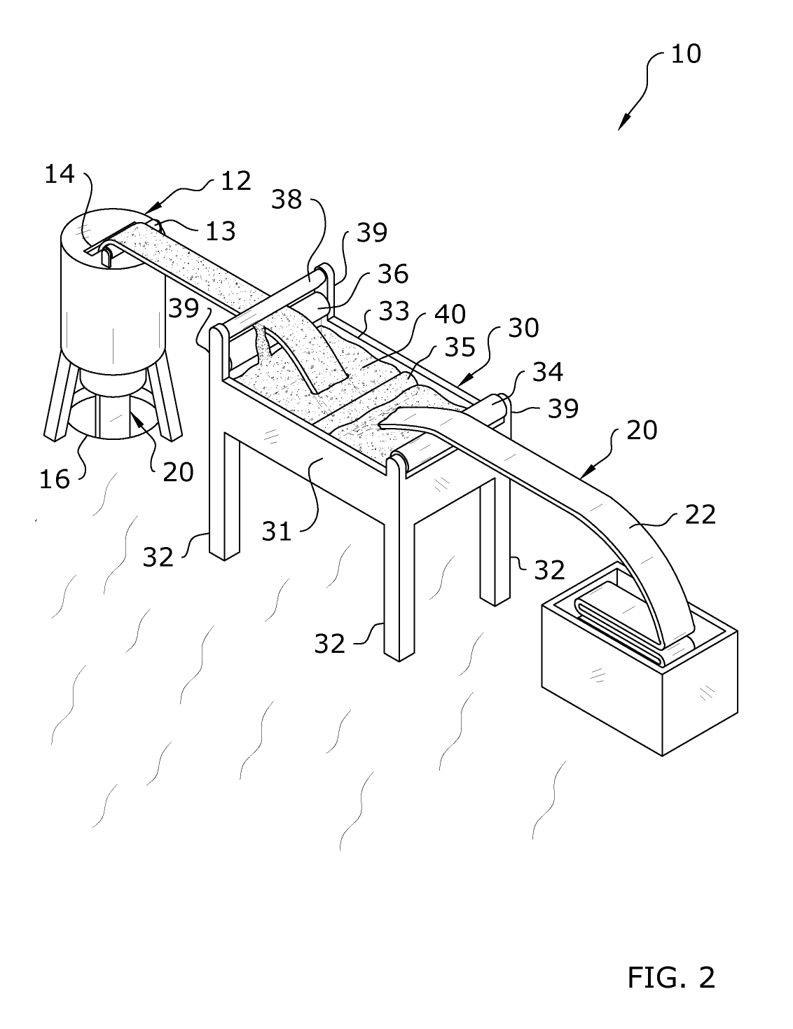

The reservoir 31 is sufficient in size to receive a volume of gel lubricant 40 sufficient to coat a significant portion of the CIPP liner 20 (e.g. 30 gallon capacity). The reservoir 31 preferably has an upper opening 33 that receives the CIPP liner 20, but various other configurations may be utilized that receive and dispense the CIPP liner 20 from the lubricant applicator 30. The reservoir 31 may have various shapes (e.g. rectangular, oval, circular), however, the reservoir 31 is preferably comprised of an elongated structure having a longitudinal axis to receive the CIPP liner 20 along the longitudinal axis as illustrated in FIGS. 1 and 2 of the drawings. The reservoir 31 may have various depths sufficient to receive a volume of gel lubricant 40 such that the upper surface of the gel lubricant 40 is above the CIPP liner 20 at least at one portion of the CIPP liner 20 being drawn through the reservoir 31.

At least one guide member is attached to the reservoir 31 to guide the CIPP liner 20, wherein the CIPP liner 20 passes beneath the at least one guide member. The at least one guide member is positioned at least partially below an upper surface of the gel lubricant 40 to ensure that at least one portion of the CIPP liner 20 passing through the reservoir 31 is completely immersed within the gel lubricant 40 to apply the gel lubricant 40 to the entire exterior surface of the CIPP liner 20.

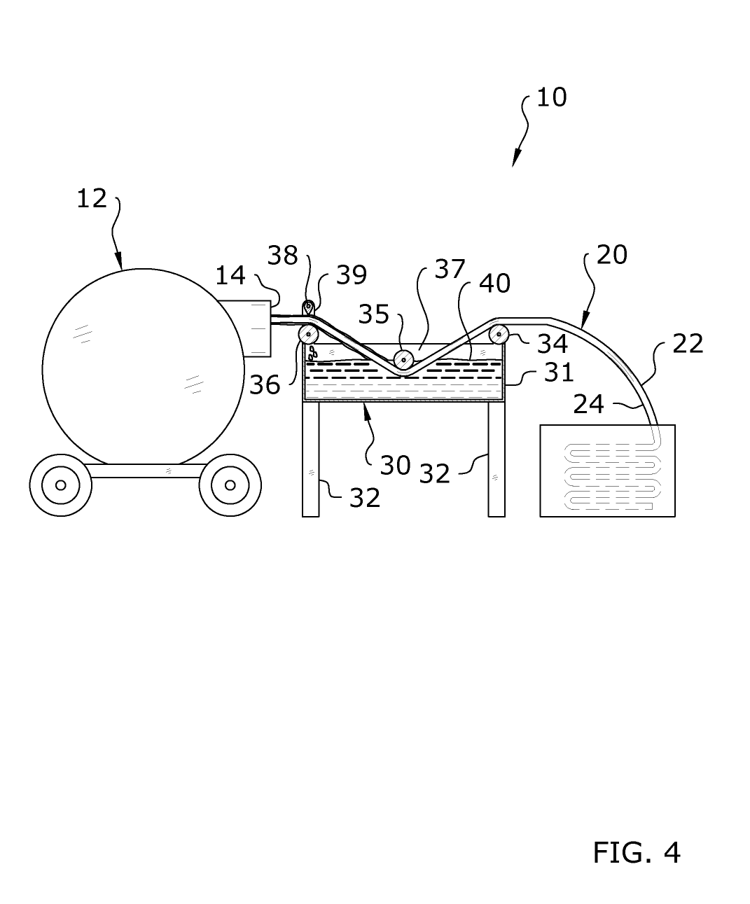

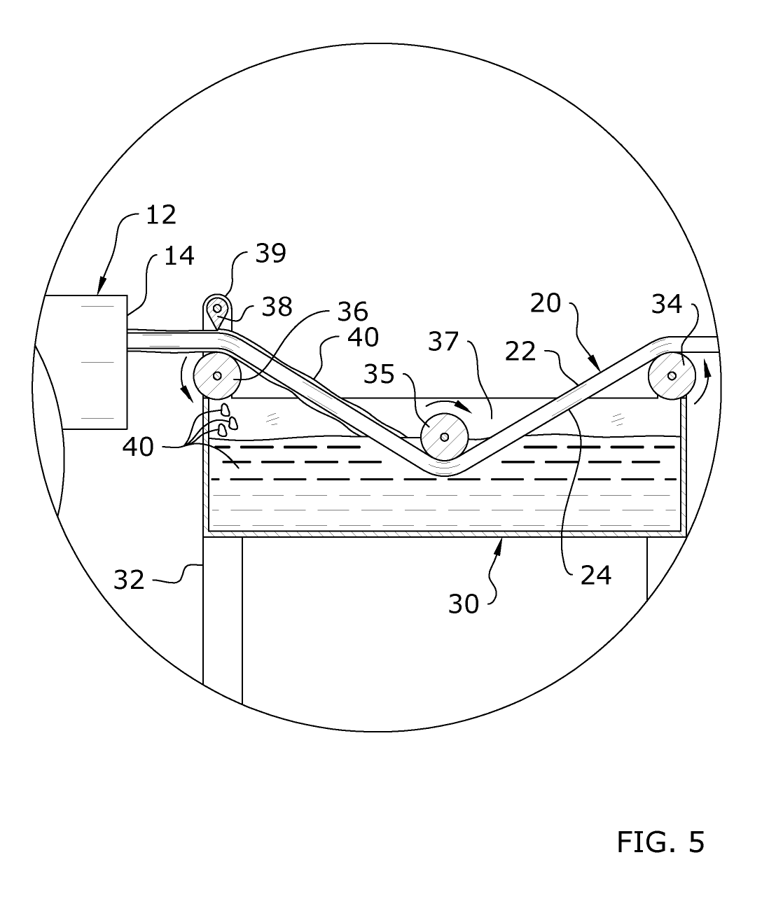

It is preferable that the guide member is comprised of a roller to engage the CIPP liner 20 in a reduced friction manner. As illustrated in FIGS. 1 through 5 of the drawings, the at least one guide member is preferably comprised of a first roller 34 rotatably attached to a first end of the lubricant applicator 30, a second roller 35 rotatably attached to a central portion of the reservoir 31 and a third roller 36 rotatably attached to a second end of the lubricant applicator 30. The CIPP liner 20 is supported by an upper portion of the first roller 34, a lower portion of the second roller 35 and an upper portion of the third roller 36 as best illustrated in FIGS. 4 and 5 of the drawings. The rollers 34, 35, 36 preferably extend across the entire width of the reservoir 31 as illustrated in FIGS. 1 through 3 of the drawings. However, the rollers 34, 35, 36 may not extend across the entire width of the reservoir 31, but the rollers 34, 35, 36 have a width equal to or greater than the width of the CIPP liner 20 in a flattened state as illustrated in FIGS. 1 and 2 of the drawings. The rollers 34, 35, 36 guide the CIPP liner 20 such that a portion of the CIPP liner 20 passing through the reservoir 31 is completely immersed within the gel lubricant 40. More than three rollers 34, 35, 36 may be utilized as can be appreciated.

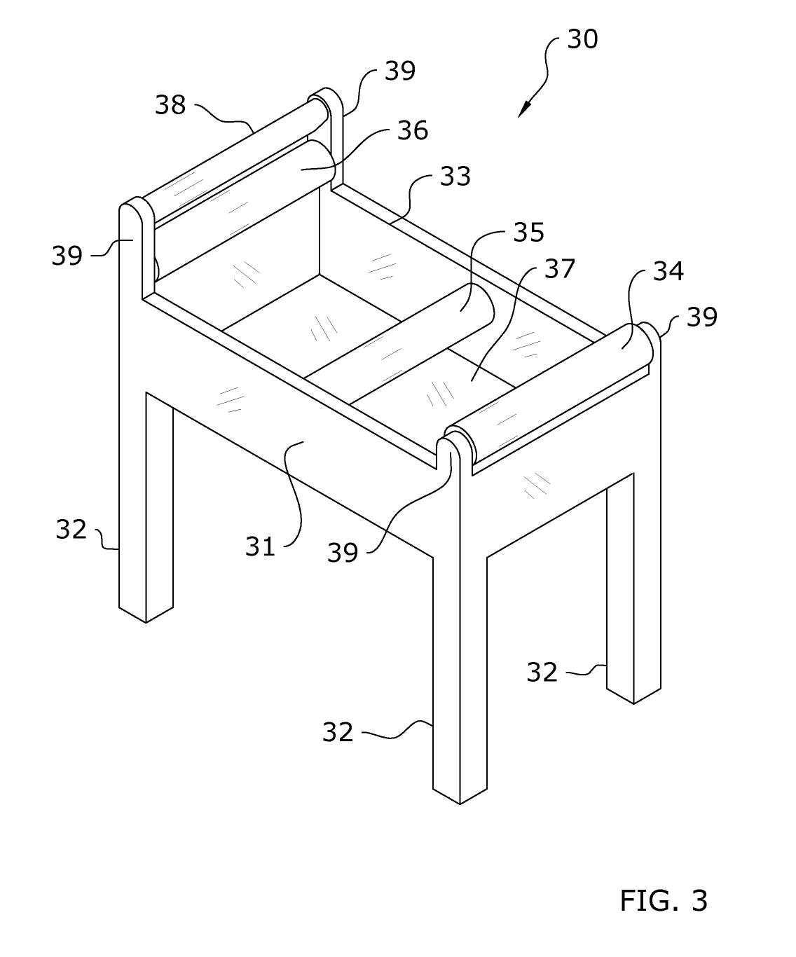

An excess lubricant remover device 38 is preferably attached near the third roller 36 as illustrated in FIGS. 1 through 5 of the drawings. The excess lubricant remover device 38 engages the first surface 22 (e.g. the upper surface) opposite of the third roller 36 and above the third roller 36 to remove excess lubricant prior to the CIPP liner 20 exiting the lubricant applicator 30. The third roller 36 assists in removing excess lubricant from the second surface 24 while the excess lubricant remover device 38 removes the excess lubricant from the first surface 22 of the CIPP liner 20. A pair of support arms 39 preferably support the excess lubricant remover device 38 above the third roller 36 in a distally spaced manner as illustrated in FIG. 3 of the drawings. The excess lubricant remover device 38 may be comprised of a roller, a squeeze or a brush that engages the entire width of the first surface 22 of the CIPP liner 20. It is preferable that the third roller 36 and the excess lubricant remover device 38 are positioned inwardly within the reservoir 31 so that excess lubricant removed from the CIPP liner 20 fall back into the interior portion 37 of the reservoir 31 for reapplication to the CIPP liner 20.

### E. Air Inverter Unit

The air inverter unit 12 may be comprised of any device capable of receiving a CIPP liner 20 and inverting the CIPP liner 20 to perform an inversion process within a conduit 18. Examples of suitable air inverter units 12 are canister/drum style units (FIGS. 1 and 4) and shooter style units (FIG. 2). The air inverter unit 12 includes an inlet opening to receive the CIPP liner 20 and an outlet opening to dispense the CIPP liner 20 in an inverted manner. For a canister type of air inverter unit 12 as shown in FIGS. 1, 4 and 5, the inlet is the same as the outlet. For a shooter type of air inverter unit 12 as shown in FIG. 2 of the drawings, a guide roller 13 is typically attached to an upper portion of the air inverter unit 12 to guide the CIPP liner 20 downwardly into an upper opening of the air inverter unit 12. Pressurized air or liquid is utilized within the air inverter unit 12 to force the inversion of the CIPP liner 20 within the conduit 18 whereby the conduit 18 expands through the conduit 18 as illustrated in FIG. 4 of the drawings.

### F. Gel Lubricant Cooling and Transportation System

Cooling the gel lubricant 40 at a cooling site prior to applying the gel lubricant 40 to the CIPP liner 20 at an installation site is important to provide the installer valuable extra cure time to install the CIP liner 20 into the conduit 18. By utilizing a cooled gel lubricant 40 applied to the CIPP liner at the installation site, the pot life (i.e. curing time) of the resin within the CIPP liner 40 is extended. The cooling site is preferably not located near the installation site, however, the cooling site may be located near or at the installation site.

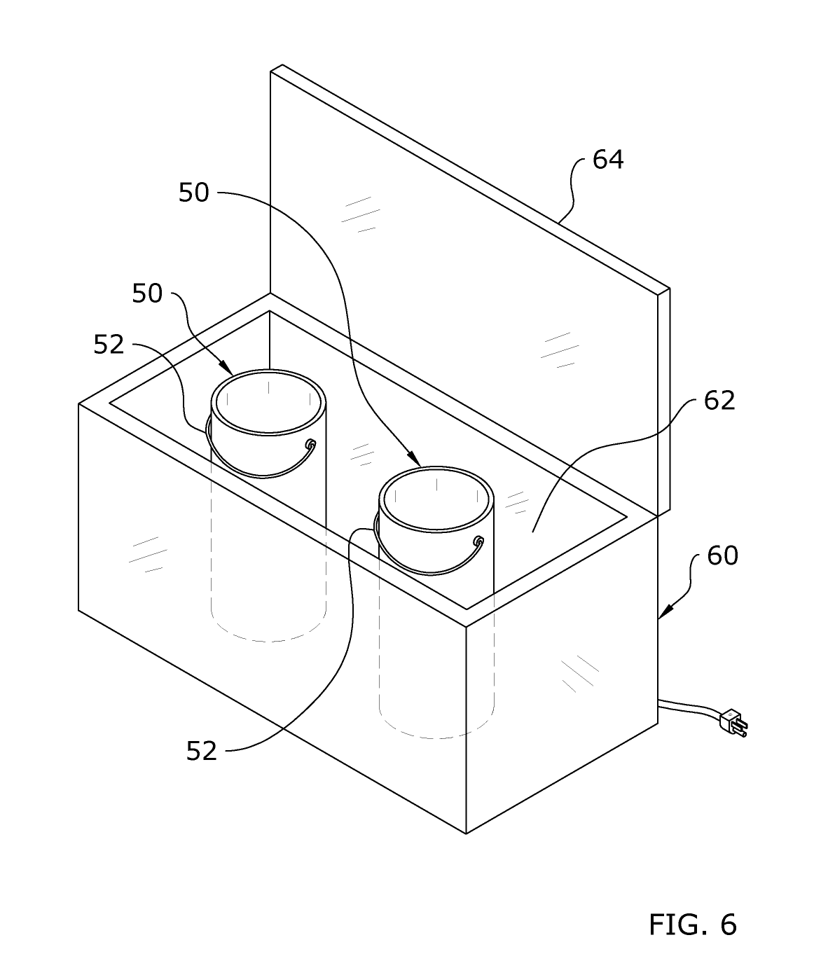

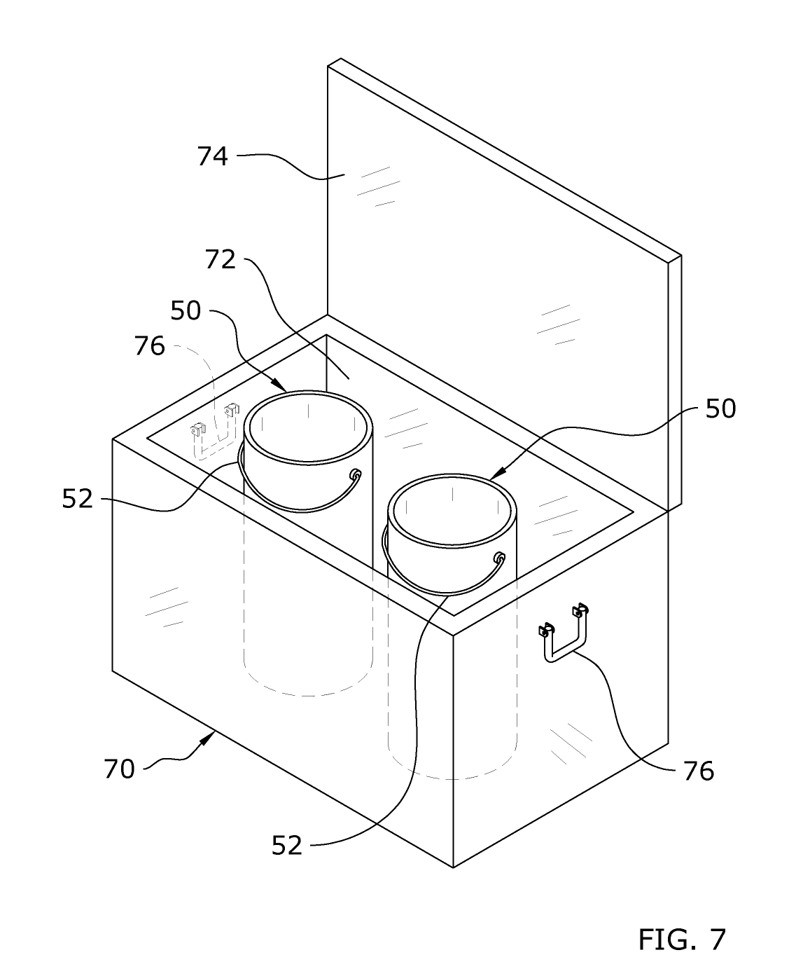

The gel lubricant is preferably stored within storage containers 50 as illustrated in FIGS. 6 and 7 of the drawings. The storage containers 50 are preferably comprised of buckets (e.g. a 5 gallon bucket) adapted to store a volume of the gel lubricant 40 with or without a respective cover, however, various other types of storage containers 50 may be utilized. The storage containers 50 preferably include a pivoting handle 52 to allow for manual positioning of the storage containers 50 into and from the cooling apparatus and into/from an insulated transportation cooler 70.

The present invention preferably utilizes a cooling apparatus 60 located at a cooling site having an interior cooling cavity 62 and a door 64 to cool one or more storage containers 50 that store a volume of the gel lubricant 40. The cooling apparatus 60 may be comprised of a conventional refrigerator or freezer capable of receiving and lowering the temperature of one or more storage containers 50. The cooling apparatus 60 cools the temperature of the interior cooling cavity 62 to a temperature at or below the target temperature of the gel lubricant 40. It is preferable that the target temperature of the gel lubricant 40 be 35 degrees Fahrenheit or lower. It is further preferable that the target temperature range of the gel lubricant 40 be within the range of 20 degrees to 35 degrees Fahrenheit before removing the storage containers 50 from the cooling apparatus for transportation to the installation site for the CIPP liner 20.

The user calculates the temperature of the gel lubricant 40 within the storage containers 50 to determine if the storage containers 50 should be removed from the cooling apparatus. In particular, the user periodically monitors the temperature of the gel lubricant 40 within the storage containers 50 using a thermometer and when the temperature of the gel lubricant 40 is equal to or below a target temperature (or within a target temperature range) the storage containers 50 are removed from the cooling apparatus.

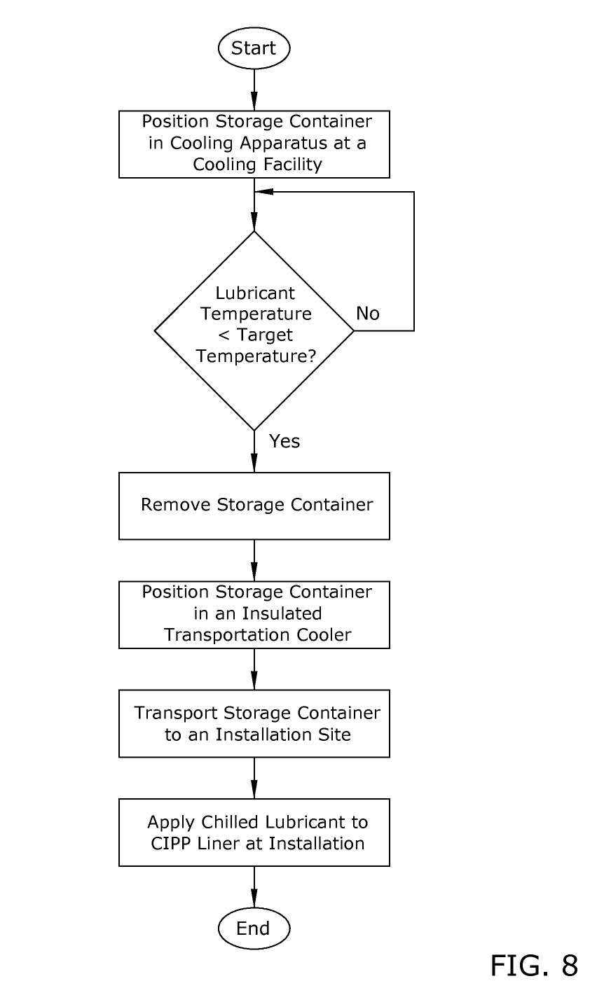

As shown in FIG. 8 of the drawings, once the gel lubricant 40 is cooled to the target temperature (or target temperature range), the storage containers 50 are removed from the cooling apparatus 60 and then the storage containers 50 are positioned within an insulated transportation cooler 60 as illustrated in FIG. 7 of the drawings. The insulated transportation cooler 60 is comprised of an interior insulated cavity 72 having one or more insulated walls surrounding the interior insulated cavity 72 and a cover 74 that allows for selective closing of the opening to the insulated transportation cooler 70. The insulated transportation cooler 70 further preferably includes two or more transportation handles 76 to allow for manual lifting and transportation of the insulated transportation cooler 70 with the storage containers 50 within the interior insulated cavity. The insulated walls of the insulated transportation cooler retain the cooled temperature of the gel lubricant 40 despite the temperature externally of the insulated transportation cooler 70. One example of a suitable insulated transportation cooler 70 is a conventional chest cooler. The insulated transportation cooler 70 is preferably comprised of a structure adapted to be transported to an installation site via a vehicle (e.g. truck or car).

Once the storage containers 50 with the gel lubricant 40 are transported to the installation site where the CIPP liner is being installed, the storage containers 50 are removed from the insulated transportation cooler 70 and the chilled gel lubricant 40 removed and applied to the CIPP liner at the installation site prior to the CIPP liner being inserted into the conduit 18 to assist in keeping the temperature of the resin within the CIPP liner lower to extend the curing time available for the installer. The chilled gel lubricant 40 is preferably at a temperature of 35 degrees Fahrenheit or lower when applied to the CIPP liner 20. The chilled gel lubricant 40 may be manually applied to the CIPP liner 20 with a brush or hand, or the gel lubricant 40 may be applied to the CIPP liner 20 using the lubricant applicator 30 as illustrated in FIGS. 1 through 5 of the drawings. When using the lubricant applicator 30, the chilled gel lubricant is dispensed into the reservoir 31 of the lubricant applicator 30 from the storage containers 50 as needed. Any chilled gel lubricant that is not needed at the time remains within the insulated transportation cooler 70 to retain a chilled temperature state.

### H. Operation.

Initially, the CIPP liner 20 is provided within a container and in a folded, flattened state as illustrated in FIGS. 1, 2 and 4 of the drawings. The distal end of the CIPP liner 20 is guided over the first roller 34, beneath the second roller 35 and over the third roller 36 as best illustrated in FIGS. 4 and 5 of the drawings. The reservoir 31 may be filled with the gel lubricant 40 prior to or after the initial insertion of the CIPP liner 20 into the lubricant applicator 30. The distal end of the CIPP liner 20 is then inserted into the receiver opening 14 of the air inverter unit 12 and then attached to the bottom portion of the air inverter unit 12 in an inverted manner such that air or liquid pressure from the air inverter unit 12 shoots the CIPP liner 20 through a manhole 16 then conduit 18 in an inverted manner during an inversion process which is widely practiced in the CIPP industry.

In use, the CIPP liner 20 is forced through the conduit 18 during the inversion process as illustrated in FIG. 4 of the drawings. The CIPP liner 20 draws itself through the lubricant applicator 30 prior to entry into the air inverter unit 12 thereby applying the gel lubricant 40 to the entire exterior surface of the CIPP liner 20. The first surface 22, the second surface 24 and the opposing edge portions of the CIPP liner 20 are completely coated with the gel lubricant 40 via the immersion of the CIPP liner 20 through the gel lubricant 40 within the reservoir 31. Any excess gel lubricant 40 is removed by the third roller 36 and the excess lubricant remover device 38 prior to entry into the air inverter unit 12. As the CIPP liner 20 is shot through the conduit 18 and inverted at the end, the friction is significantly reduced by the gel lubricant 40 that is effectively applied to the exterior surface of the CIPP liner 20. After the CIPP liner 20 is installed within the conduit 18, the gel lubricant 40 eventually evaporates without leaving any significant residue within the interior of the CIPP liner 20 and the CIPP liner 20 is then cured (e.g. by heat, UV light) within the conduit 18 to cure the resin within the CIPP liner 20. When the gel lubricant 40 level gets low within the reservoir 31, the user may add more gel lubricant 40 as desired. Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A method of applying a chilled lubricant to a CIPP liner, comprising:
providing a CIPP liner having an exterior surface;
providing a gel lubricant, wherein said gel lubricant has a temperature of 35 degrees Fahrenheit or less; and
applying said gel lubricant to said exterior surface of said CIPP liner.

2. The method of applying a chilled lubricant to a CIPP liner of claim 1, wherein said CIPP liner is initially in a flattened state and wherein said exterior surface is comprised of a first surface and a second surface in opposition to said first surface, wherein said first surface is parallel with respect to said second surface.

3. The method of applying a chilled lubricant to a CIPP liner of claim 2, wherein said step of applying said gel lubricant includes applying said gel lubricant to both said first surface and said second surface.

4. The method of applying a chilled lubricant to a CIPP liner of claim 3, wherein said step of applying said gel lubricant includes applying said gel lubricant to opposing edge portions of said CIPP liner.

5. The method of applying a chilled lubricant to a CIPP liner of claim 1, wherein said step of applying said gel lubricant is comprised of applying said gel lubricant with a manual applicator.

6. The method of applying a chilled lubricant to a CIPP liner of claim 6, wherein said manual applicator is comprised of a brush, a roller or a cloth.

7. The method of applying a chilled lubricant to a CIPP liner of claim 1, wherein said gel lubricant is comprised of a water and polymer solution forming a viscous gel.

8. The method of applying a chilled lubricant to a CIPP liner of claim 1, wherein said gel lubricant has a viscosity greater than 5,000 cPs at 25 degrees Celsius.

9. The method of applying a chilled lubricant to a CIPP liner of claim 1, wherein said gel lubricant has a viscosity greater than 9,500 cPs at 25 degrees Celsius and less than 250,000 cPs.

10. The method of applying a chilled lubricant to a CIPP liner of claim 1, wherein said gel lubricant is not comprised of a liquid lubricant.

11. The method of applying a chilled lubricant to a CIPP liner of claim 1, including the step of inserting said CIPP liner into an air inverter unit after said step of applying said gel lubricant.

12. The method of applying a chilled lubricant to a CIPP liner of claim 11, including the step of inserting said CIPP liner into a conduit from said air inverter unit.

13. The method of applying a chilled lubricant to a CIPP liner of claim 12, wherein said step of inserting said CIPP liner into a conduit includes inverting said CIPP liner within said conduit.

14. The method of applying a chilled lubricant to a CIPP liner of claim 1, wherein said step of applying said gel lubricant is comprised of applying said gel lubricant with a lubricant applicator that said CIPP liner passes through prior to insertion into a conduit.

15. The method of claim 14, wherein said lubricant applicator is comprised of a reservoir having an interior portion that stores a volume of said gel lubricant and at least one guide member attached to said reservoir, wherein said CIPP liner passes beneath said at least one guide member.

16. The method of claim 15, wherein said at least one guide member is comprised of a first roller rotatably attached to a first end of said lubricant applicator, a second roller rotatably attached to a central portion of said reservoir and a third roller rotatably attached to a second end of said lubricant applicator, wherein said CIPP liner is supported by an upper portion of said first roller, a lower portion of said second roller and an upper portion of said third roller.

17. The method of claim 1, wherein said gel lubricant has a temperature of between 20 degrees Fahrenheit to 35 degrees Fahrenheit.

18. The method of claim 1, including the steps of:
chilling said gel lubricant at a cooling site to a temperature of between 20 degrees Fahrenheit to 35 degrees Fahrenheit; and
transporting said gel lubricant from said cooling site to an installation site after said step of chilling.

19. The method of claim 1, including the steps of:
providing a volume of said gel lubricant within a storage container;
positioning said storage container with said gel lubricant into a cooling apparatus;
chilling said gel lubricant within said storage container within said cooling apparatus to a temperature of between 20 degrees Fahrenheit to 35 degrees Fahrenheit; and
removing said storage container with said gel lubricant from said cooling apparatus after said gel lubricant is chilled to a temperature of between 20 degrees Fahrenheit to 35 degrees Fahrenheit.

20. The method of claim 19, including the steps of:
positioning said storage container into an insulated transportation cooler after said step of removing said storage container; and
transporting said storage container within said insulated transportation cooler to an installation site.
